(19) United States
(12) Patent Application Publication
(10) Pub. No.: US 2026/0187063 A1
(43) Pub. Date: Jul. 2, 2026

(54) PLAN VALIDATION

(71) Applicant: Intuit Inc., Mountain View, CA (US)

(72) Inventors: Dusan BOSNJAKOVIC, Los Angeles, CA (US); Prarit LAMBA, San Diego, CA (US); Shivakumara NARAYANASWAMY, San Jose, CA (US); Anmol JOSHI, San Diego, CA (US)

(21) Appl. No.: 19/001,960

(22) Filed: Dec. 26, 2024

(51) Int. Cl. G06F 16/2452; G06F 16/21; G06F 16/2455

(52) U.S. Cl. CPC G06F 16/24524; G06F 16/211; G06F 16/24564

(57) ABSTRACT

Certain aspects of the disclosure provide techniques for validating function plans by a device. An example method includes receiving, as input, a function plan comprising a function definition that comprises a set of features associated with a function, a user query, and a function schema that corresponds to the function included in the function plan; determining a hallucination in the function definition by comparing the set of features of the function definition with one or more corresponding features included in the user query or the function schema; determining that a correct feature corresponding to the hallucination is not included in either the user query or the function schema; performing function-specific disambiguation to obtain the correct feature; modifying the function definition by replacing the hallucination with the correct feature; and executing the function plan with the modified function definition.

### BACKGROUND

### Field

Aspects of the present disclosure relate to systems and methods for validating function plans, such as in the context of generating a function plan using generative artificial intelligence.

### Description of Related Art

Generative artificial intelligence (GenAI) refers to machine learning models that are able to create new content based on patterns and information learned from training data in combination with a user prompt. The user prompt provides instruction to the model on what new content to generate and how to generate that new content. Notably, the model is able to generate new content based on both the actual information (e.g., facts, knowledge) included in the training data, as well as patterns, insights, and model parameter weights learned from the training data.

GenAI models are able to generate new content in many different forms, including text, image, audio, and even video. For example, to facilitate text generation, some GenAI models are configured as language models (LMs). An LM is generally a type of machine learning model that is designed to understand, generate, and manipulate human language. More specifically, an LM is a probabilistic framework that determines the likelihood of a sequence of words or tokens. At its core, a LM attempts to predict the probability of the next word in a sentence given the preceding words. The model estimates these probabilities based on the patterns it learned during training. LMs are useful in natural language processing (NLP) and computational linguistics for performing a range of tasks involving human language.

LMs have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

While language models represent a transformative force in many industries by assimilating vast amounts of knowledge, such as to build conversation-driven applications, these models are not without limitation. For example, while a powerful tool, an LM may generate incorrect or made-up content, often referred to as hallucinations, when generating the new content. These hallucinations in the generated content can lead to the degradation or failure of downstream applications that rely on the generated content as input.

### SUMMARY

Certain aspects provide a computer-implemented method for validating function plans. The method includes receiving, as input, a function plan comprising a function definition that comprises a set of features associated with a function, a user query, and a function schema that corresponds to the function included in the function plan; determining a hallucination in the function definition by comparing the set of features of the function definition with one or more corresponding features included in the user query or the function schema; determining that a correct feature corresponding to the hallucination is not included in either the user query or the function schema based on determining the hallucination in the function definition; performing function-specific disambiguation to obtain the correct feature based on determining that the correct feature is not included in the user query or the function schema; modifying the function definition by replacing the hallucination with the correct feature; and executing the function plan with the modified function definition.

Certain aspects provide a method for validating function plans by a device. The method includes receiving, as input, a function plan comprising a function definition that comprises a set of features associated with a function a user query, and a function schema that corresponds to the function included in the function plan; determining a hallucination in the function definition by comparing the set features of the function definition with one or more corresponding features included in the user query or the function schema; determining whether a correct feature corresponding to the hallucination is included in either the user query or the function schema based on determining the hallucination in the function definition; performing function-specific disambiguation to obtain the correct feature if the correct feature is not included in the user query or function schema; modifying the function definition to include the correct feature; and executing the modified function plan based on whether the correct feature is included in the user query or the function schema.

Certain aspects provide a computer-implemented method for validating function plans. The method includes receiving, as input, a first set of features associated with a function definition, and a second set of features associated with a user query and a function schema; comparing the first set of features and the second set of features; identifying a hallucination in the first set of features by determining that at least one feature in the first set of features does not match at least one corresponding feature included in the second set of features; determining that a correct feature corresponding to the hallucination is not included in the second set of features based on identifying the hallucination; selecting a clarification question from a set of pre-defined clarification questions corresponding to the function definition based on determining that the correct feature is not included in the second set of features, wherein the clarification question is configured to prompt a user to provide the correct feature; transmitting the clarification question to a user interface; receiving user input comprising the correct feature based on the clarification question; extracting the correct feature from the user input; modifying the function definition by replacing the hallucination with the correct feature; and executing the modified function plan.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a computing system configured to perform plan validation.

FIG. 2 depicts a flowchart diagram of a method for performing plan validation on a function plan.

FIG. 3 depicts an example of a function schema, a function plan and a function definition.

FIG. 4 depicts another example of a function schema.

FIG. 5 depicts a flowchart diagram of a method for performing function-argument disambiguation when a hallucination has been detected in the function definition and a corresponding correct feature is included in the user query.

FIG. 6 depicts a flowchart diagram of a method for performing function-argument disambiguation when a hallucination has been detected in the function definition and a corresponding correct feature is included in the function schema.

FIG. 7 depicts a flowchart diagram of a method for performing function-argument disambiguation when a hallucination has been detected in the function definition and a corresponding correct feature is included in the user query.

FIG. 8 depicts a flowchart diagram of a method for the clarification process illustrated in FIG. 7.

FIG. 9 depicts a flowchart diagram of an example of the function-specific disambiguation process illustrated in FIG. 8.

FIG. 10 depicts a method for validating function plans.

FIG. 11 depicts another method for validating function plans.

FIG. 12 depicts another method for validating function plans.

FIG. 13 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Automated assistants are applications that can be used to provide users with product and/or service assistance in a comprehensive and cost-effective manner. One type of automated assistant comes in the form of a chatbot, which is a software feature designed to simulate a conversation with human users. The chatbot is typically configured as a text-based user interface, much like a smart-phone's text messaging user interface, where a user is able to type an input which is submitted to the software and the software outputs a response to the user input. In some configurations, the inputs and outputs appear as distinct text bubbles in sequential order as a means to display the conversation to the user.

In some cases, automated assistants are configured to provide responses to user inputs based on a preset or rule-based conversation response. Rule-based automated assistants use if/then logic to respond to the user input based on a previously generated map of potential user inputs and corresponding outputs thought to be helpful in responding to the user inputs. Such automated assistants can also access pre-approved content databases to retrieve additional information or links to provide other helpful information to the user if the previously generated rule matches one of the content datasets included in the pre-approved content databases. While these rule-based automated assistants provide consistent and pre-vetted responses to users, such assistants are constrained and limited in their ability to provide tailored and customized responses to user inputs, especially when the user inputs do not match well to any of the pre-defined rules or conversation maps. For example, if a user input is not addressed by a pre-defined rule or conversation map, a rule-based automated assistant may provide an error, fail to process the user, and/or escalate to a human intervention, which is resource-intensive and impacts user experience.

In order to improve the quality and customization of outputs, automated assistants may employ different machine learning models, such as language models (LMs), that can be trained to generate responses to different user questions or queries. Some LMs are trained specifically for text generation, often referred to as large language models (LLMs) because of the extensive amount of data on which they are trained and the size of these models relative to other LMs. LMs are configured to receive a user input (e.g., user query) that requests a text output from the model. The LM then generates a text output based on the user input using the information, context, and model parameter weighting learned during the LM's extensive training process.

In addition to generating text outputs, users may request an automated assistant to perform one or more specified actions, including accessing databases, generating or transmitting documents, or other tasks. For example, a user may request that the automated assistant gather information and then generate a document, such as a report or email, to fill in a form. To facilitate the completion of these actions or tasks, an automated assistant can be configured to access function databases that store different functions or use application programming interfaces (APIs) to call functions to perform various tasks. These functions can be static or rule-based functions, machine learning-based functions, or even generative functions using LLMs described above. Functions are typically defined based on a function schema, which includes the function name, arguments (e.g., function inputs), the function code, and function outputs. Each argument may associated with at least a value and a type (e.g., string, integer, etc.). Each value and/or type may be associated with an acceptable range, list, or other boundaries defined in the function schema to ensure proper functionality and accurate outputs of the function.

Thus, some automated assistants may be configured to use a combination of both generative models and other functions to be able to generate high quality, tailored responses for a wide range of different user inputs. However, challenges arise with the usage of LM-based assistants, including LLM-backed automated assistants, such as introducing hallucination into various steps of the output (e.g., response to user input) generation process. “Hallucination” refers to the phenomenon where a model generates incorrect or “made up” outputs that appear to be unrelated to the user input and/or not based on rational or accurate information. This is problematic in general when a model is used to generate text outputs in response to a user query, such as if the model hallucinates and provides incorrect information or unrelated information to the user.

Hallucinations becomes especially problematic when generative models are used to call other functions that have specific argument requirements. For example, if a model hallucinates, either by changing a value included in the user input or making up a value that was not included in the user input, and attempts to send those hallucinated values to a function as the function arguments, that function will not return the correct results back to the system/user. In some instances, the LLM may not even call the right function if it has hallucinated the function name. These inaccuracies can be compounded in situations where multiple dependent functions are called upon as part of a function plan to facilitate the output generation process. A “function plan” refers to the designation of which functions are to be used and in what order the function are to be executed in order to produce the results that will be used as part of the response to the user input.

In order to address the shortcomings of the LLMs, some validation techniques have been employed on the model input side in order to help prevent or mitigate hallucinated outputs. For example, user inputs may be appended with pre-defined system prompts that are sent along with the user inputs to further define, limit, or otherwise instruct the model on how to generate the requested outputs. Additionally, some validation techniques have been employed after the model generates the output to modify and fix the output prior to presenting the output to the user. Notably, systems may be limited in how much they are able to modify and the fix the output, based on constraints of rule-based modifications or without running the risk of introducing more hallucination if using another LLM to perform the validation modifications.

However, such validation techniques still do not address the technical problem of the LLM generating hallucinations in intermediary content that may have been created during the intermediary steps of the output generation, including the calling and execution of different functions as part of a function plan. For example, in some instances, hallucinations can lead to improper or failed function execution or lead to irrelevant or incoherent content generation related to the user query. When hallucinations occur in these intermediary steps of output generation, this can lead to increased drain on computational resources, such as processer usage associated with re-addressing hallucination issues. Further, systems can incur increased processor usage and system occupation when executing hallucinated function calls because such function calls cannot be executed efficiently. Additionally, hallucinations can lead to increased bandwidth usage associated with looping in a human to resolve these hallucination issues.

Accordingly, intermediary validation techniques beneficially would be able to fix hallucination issues prior to functions being executed, thereby improving the efficiency and accuracy of both the individual function output, as well as the overall user response output generation.

Systems and methods are described herein which overcome the aforementioned technical problems and improve upon the state of the art by introducing plan validation that performs a validation check on the function plan, prior to executing the functions of function plan, to identify and fix hallucinations that may have occurred between receiving the user input and generating the function plan.

In some aspects, the plan validation utilizes a validation component that is configured to perform hallucination detection and/or function argument disambiguation. The validation component is configured to perform hallucination detection by comparing various validation component inputs to each other, including user-generated inputs and intermediary model outputs, to ensure that specific data is consistent across the validation components. For example, the validation component inputs can include the original user query, any function schemas used in creating the function plan, and/or one or more function definitions selected by the system or function calling model that will be sent to the function execution component.

As part of hallucination detection, the validation component checks to see if the function name and argument type in the function definition matches the function name and argument type defined in the function schema for the corresponding function. The validation component also checks to see if the argument value included in the function definition matches an argument value provided by the user in the user query. If all of the validation checks come back as true, the function definitions are sent to the function execution component to execute each function in the function plan. However, if one or more of the validation checks come back as false, the system is configured to perform function argument disambiguation.

Function argument disambiguation is performed by identifying which parts of the function plan incurred false validation checks and then fixing the identified issues. For example, in some aspects, the system is able to automatically replace the incorrect function name, argument value, or argument type found in the function plan with the correct function name, argument value and/or argument type found in the customer query and/or function schema. For example, by automatically identifying and correcting hallucinations related to the function name, argument value, or argument type, systems are able to insert and generate computer code without human intervention. In this manner, the function plan is updated so that the correct function name, function argument value, and function argument type are passed to the function execution component automatically because the correct information was already included in the user query and function schema.

For example, if the user query included a request “I need help uploading a K1 form” but then the corresponding function plan that was generated included an argument value of a 1098 form for the form upload function, then the system would detect that the function plan included the hallucination of the form name (e.g., the 1098 form) which was not the form specified in the user query. The system would then replace the argument value field of the function plan with the correct value (“K1”) that is based on the user query. By replacing the incorrect argument value (“1098”) with the correct argument (“K1”) at this stage, the function plan is able to be executed without having to incur additional usage of computational resources, such as processing and memory usage, that would have been used to correct any downstream deficiencies or failures due to an incorrect argument value. The newly corrected function plan is then sent to the function execution component to execute the function plan.

On the other hand, in some instances, the correct or necessary information was not included in either the user query or function schema. In other words, the function plan included a hallucination where the model made up a value that was never actually included in the user query or function schema. In such instances, the system is configured to access a pre-defined list of clarification questions that can be used to prompt the user to enter additional information in order to complete the function plan in the correct manner. The additional information entered by the user is then used to replace the incorrect information in the function plan.

In some instances, a pre-defined list refers to a list of clarification questions that has been configured and stored in memory (to be accessed at a subsequent time), rather than generated on-the-fly or during run-time, such as by an LLM. By pre-defining lists of clarification questions, systems avoid latency issues that could occur with creating new clarification questions during run-time. Accessing pre-defined lists of clarification questions that are already indexed with corresponding functions, is less processor-intensive and may lead to better outcomes than free-form generation. For example, the pre-defined lists can also be verified prior to being used in the function argument disambiguation. Additionally, because these lists are pre-defined, systems avoid introducing new hallucinations into the questions being used to clarify and correct existing hallucinations in the function definitions.

For example, if the user query included a request “I need help uploading a form” but then the corresponding function plan that was generated included an argument value of a 1098 form for the form upload function, then the system would detect that the function plan included the hallucination of a form (e.g., the 1098 form) which was not specified in the user query. Because the form was not specified in the user query, the system would then access the set of pre-defined clarification questions associated with disambiguating this type of hallucination and prompt the user with a question from the set of pre-defined clarification questions (e.g., “What's the name of the form you need help with?”). The user can then respond with the type of form they need help uploading (e.g., K1), and the system replaces the incorrect value of “1098” with the correct value of “K1”. The newly corrected function plan is then sent to the function execution component to execute the function plan.

By employing plan validation, including both hallucination detection and function argument disambiguation, in this manner, the systems and methods described herein achieve many technical benefits over the state of the art in providing technical solutions to the technical problems associated with automated assistants utilizing a combination of generative models and function calling components.

For example, by performing plan validation prior to executing any of the functions in the function plan, the system ensures that each function is properly defined in the function plan with the correct function name, argument value, and argument type. This helps to ensure functions in the function plan are executed correctly and provide accurate results that will be used in generating a final output that will be presented to the user in response to the user query that was submitted. This avoids any unnecessary drain on computational resources such as processor or memory usage that would otherwise be required if the results and corresponding final output are inaccurate, thus requiring further correction or additional output generation. Further, because each function in the function plan is separately validated prior to any of the functions being executed, if a function plan included multiple dependent functions (e.g., a subsequent function's input is dependent on a first function's output), then any errors that might have resulted from hallucinations in the first function's execution are corrected and prevented from being propagated to downstream functions. This also reduces the usage of processor and memory usage because each function can be executed correctly and efficiently, without having to perform trouble-shooting or mitigating failed function states due to hallucinations in the function definitions.

Such errors could result in breaking of the function or inability of the function to execute and/or causing one or more functions to return incorrect results. These errors could then be included in the final response presented to the user, thereby degrading the quality and accuracy of the information presented to the user. Degraded responses can significantly harm the user experience while interacting with the automated assistant. Thus, the disclosed aspects beneficially prevent the degradation of user responses, thereby preventing harm to the user experience while interacting with the automated assistant.

Additionally, because the plan validation is based on rule-based comparison to identify mismatched values in the function plan, the system beneficially avoids introducing further hallucinations during this validation stage. Accordingly, because the plan validation is able to fix any previously generated hallucinations in the manner, the system is still able to leverage the robust generation capabilities of the models in the system that are used to generate the function plan without sacrificing accuracy during execution of the function plan.

In this manner, by identifying and fixing hallucinations in the function plan, the system is able to prevent errors in executing the functions. By fixing current errors and preventing further ones, the function plan execution is improved, thereby improving the final response that is presented to the user. This allows for high quality and accurate responses to be presented to the users which improves the user experience while interacting with the automated assistant. Additionally, because hallucinations are caught prior to executing any functions, the system is able to process the user query faster and more efficiently, without having to employ additional error mitigation techniques.

Further, because the system is beneficially equipped with function-specific clarification questions, the system is able to quickly and efficiently identify missing information in the user query and obtain any additional information that is needed to properly execute the function plan. This ensures that the results returned from executing the function plan are relevant and accurate with respect to what the user originally intended when submitting their user query.

### Example Computing Environment

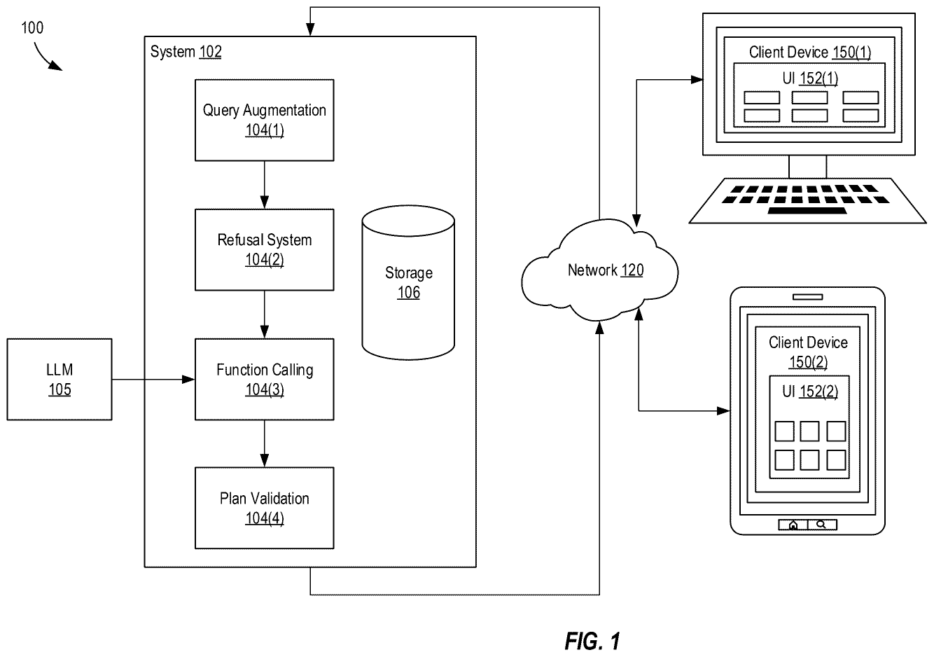

FIG. 1 depicts an example system 100 comprising a sub-system (e.g., system 102) in communication with a machine learning model (e.g., LLM 105) and one or more client devices (e.g., client device 150(1)-(2)). System 102 further comprises one or more microservices 104 that are implemented in series but also can be independently deployable services (or software) that may make up an application. Microservices 104 may enable segmented, granular level functionalities within a larger system infrastructure.

As shown in FIG. 1, system 100 comprises client devices 150(1)-(2) (collectively referred to herein as “client devices 150”) and system 102 interconnected through a network 120. Network 120 may be, for example, a direct link, a local area network (LAN), a wide area network (WAN), such as the Internet, another type of network, or a combination of one or more of these networks.

System 102 may be constructed on a server grade hardware platform and include components of a computing device such as, one or more processors (central processing units (CPUs)), one or more memories (random access memory (RAM)), one or more network interfaces (e.g., physical network interfaces (PNICs)), storage 106, and other components (e.g., only storage 106 is shown in FIG. 1).

System 102 in system 100 may host a plurality of microservices 104(1)-(4) (collectively referred to herein as “microservices 104”). The microservices 104 may be deployed using virtual machines (VMs) and/or container(s) running on system 102 (e.g., where system 102 is running a hypervisor (not shown) used to abstract processor, memory, storage, and networking resources of system 102 hardware platform).

Client device 150(1) and client device 150(2) may each include a user interface (UI) 152(1), 152(2), respectively, which may be used to communicate with, at least, a first microservice 104(1), a second microservice 104(2), and/or a third microservice 104(3) using the network 120. For example, communication between client devices 150 and a microservice 104 may be facilitated by one or more application programming interfaces (APIs). Examples of client devices 150 may include a smartphone, a personal computer, a tablet, a laptop computer, and/or other devices.

As shown in FIG. 1, the microservices 104 may include, at least, the first microservice 104(1), the second microservice 104(2), the third microservice 104(3), and the fourth microservice 104(4).

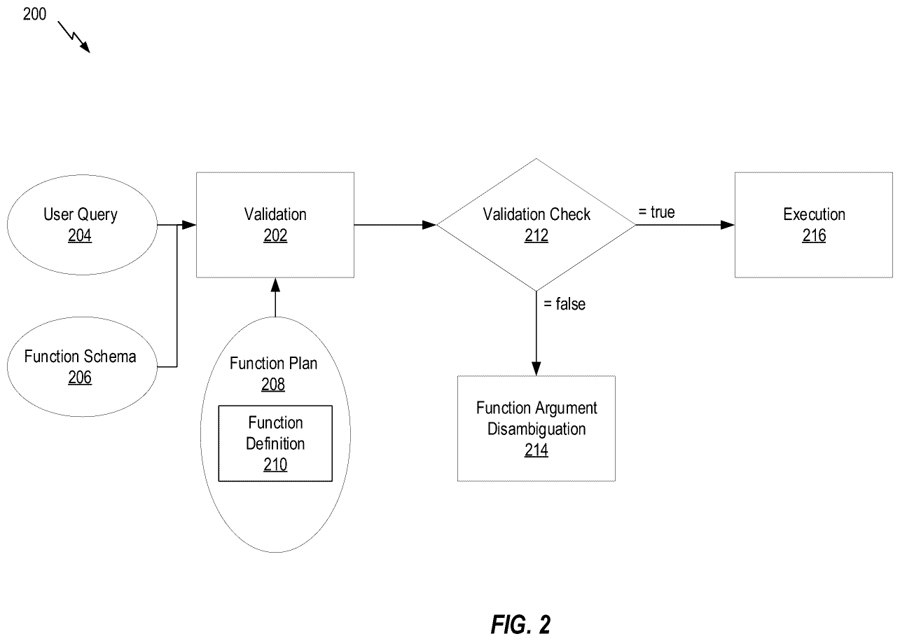

In certain embodiments, the first microservice 104(1) implements a query augmentation system. Additionally, the second microservice 104(2) implements a refusal system. In some aspects, the refusal system applies function-level thresholds to semantic scores of corresponding functions at run-time to narrow down the list of potential functions. By implementing run-time filtering, the refusal system ensures that only the most relevant function are considered for the final planning stage by filtering out less relevant functions based on corresponding semantic scores not meeting the function-level thresholds. The third microservice 104(3) implements a function calling system that performs function API contract building to construct API contracts required to call the appropriate function, disambiguation to resolve any ambiguities in the user queries or API functions, and creating planning strategies to determine the sequence and nature of API calls/functions needed to respond to the user query. The fourth microservice 104(4) implements a plan validation system, described in more detail with reference to FIGS. 2-13 herein, which facilitates hallucination detection and function argument disambiguation to clarify and correct any hallucinations in the arguments required by the functions at run-time.

Though FIG. 1 depicts each of system 102, storage 106, client device 150(1), and client device 150(2) as single devices for ease of illustration, system 102, storage 106, client device 150(1), and/or client device 150(2) may be embodied in different forms for different implementations. Further, though FIG. 1 depicts only a single sub-system (e.g., system 102) and two client devices 150, other embodiments may include more or less sub-systems and/or client devices 150, and client devices 150 may use any combination of microservices 104 on any system 102 where microservices 104 are deployed.

FIG. 2 depicts a flowchart diagram 200 of a method for performing plan validation on a function plan. In some aspects, the operations of diagram 200 may be performed by a processing system or apparatus such as system 100, system 102, client devices 150, or system 1300. As an overview of components and elements illustrated in FIG. 2, a set of inputs are provided to a validation component 202 that compares features associated with the different inputs. The set of inputs includes user query 204, function schema 206, and function plan 208. Function plan 208 comprises at least one function definition (e.g., function definition 210) that corresponds to function schema 206. Notably, by providing user query 204 to the validation component, the user query 204 acts as ground truth data for the validation component 202 to check against the other inputs. For example, the validation component 202 is able to validate the features of the inputs with the features of the user query 204. In this manner, the validation component 202 is configured to confirm that the system or LLM-generated inputs (e.g., the function schema 206 and function plan 208) will actually be helpful in generating a response to the user query 204 because the validation component 202 checks whether the function and corresponding arguments related to the function schema 206 and function definition 210 will actually facilitate the generation of a relevant answer to the user query 204. Additionally, function schema 206 is provided as input to help facilitate the semantic analysis of the user query 204 and to assist the LLM in understanding how to access and execute the corresponding function.

Validation component 202 is configured to compare the features of the function plan 208, including the respective features of each function definition 210 included in the function plan, with the features of the function schema 206 and the features of the user query 204, to determine if a hallucination is present in the function definition 210. Examples of the features are provided elsewhere herein.

If the features of function definition 210 match the corresponding features in the function schema 206 and user query 204, validation check 212 returns “true”, meaning that function definition 210 did not include any hallucinations when function definition 210 was generated. If no hallucinations are found, function plan 208, including function definition 210, are transmitted to execution component 216 to execute function plan 208 without modifying function definition 210. By including a validation check at this point of the plan validation, computational resources are saved by avoiding usage during unnecessary function argument disambiguation, for example, if no hallucinations exists and the function plan 208 can be executed without modification.

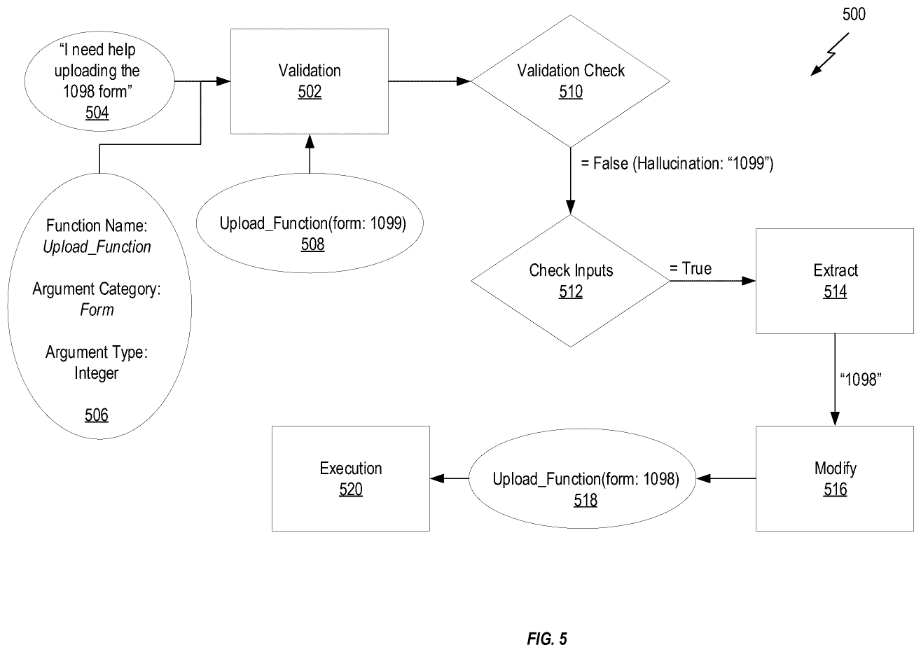

However, in some instances, hallucinations are detected when one or more features of the function definition 210 do not match one or more corresponding features in the function schema 206 and/or user query 204. Accordingly, if validation check 212 returns “false”, meaning that one or more hallucinations were detected in function definition 210, the system (e.g., system 100, system 102) is configured to perform function argument disambiguation 214, described in more detail with reference to FIGS. 5-9 below, and modify function definition 210 prior to execution of function plan 208 to correct any hallucinations that were detected in the function definition 210. By correcting any hallucinations prior to execution of the function plan, less computational resources are used to fix downstream issues related to the hallucinations, especially where downstream issues require more extensive computational resource to fix than correcting the hallucinations prior to function execution.

Each of the aforementioned components and elements of FIG. 2 will now be described in more detail. User query 204 comprises user input that is received at a user interface, such as one of user interfaces 152 of FIG. 1. The user interface is configured to facilitate a user's interaction with an automated assistant. For example, a user may access a chatbox user interface associated with or provided by the automated assistant and submit a user query 204 that prompts the automated assistant to help with one more tasks. Some example tasks include asking for help in uploading a form or requesting additional information, as described in more detail in connection with FIGS. 5-9.

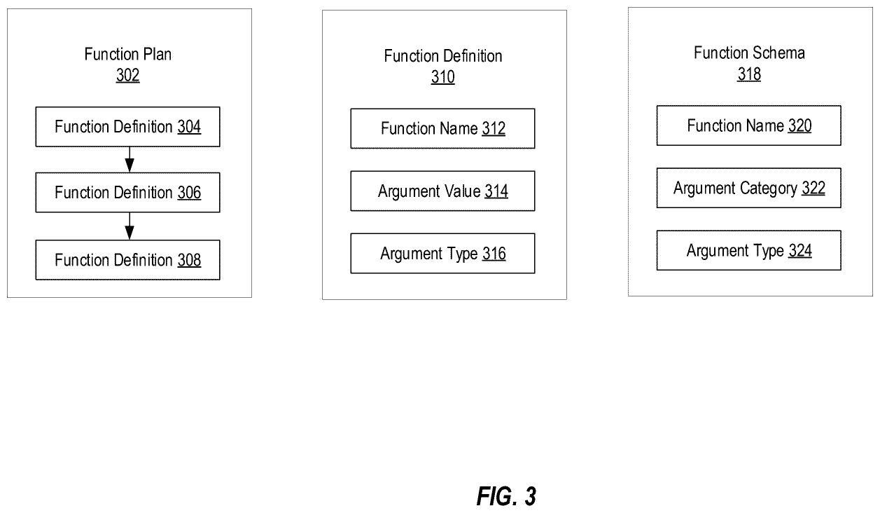

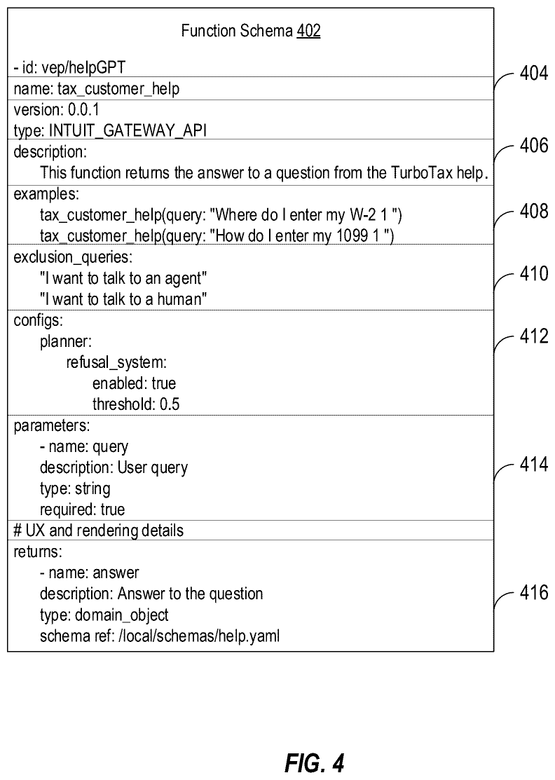

The function schema 206, shown in further detail in FIGS. 3-4, comprises features associated with a particular function that can be executed as part of the function plan 208. FIG. 3 provides an example of a function schema 318, as well as a function plan 302 and a function definition 310 (which are described later). Function schema 318 (representative of function schema 206) is shown comprising a function name 320, an argument category 322, and an argument type 324. A function name 320 is an identification label associated with a particular function. The function name 320 may be used to call or execute the function. An argument category 322 is a classification of arguments that are used as inputs to the function. An argument type 324 is a type of argument that is compatible with the functionality of the function (e.g., integer, string, binary, etc.). In some instances, the feature for argument type 324 found in function schema 206 is referred to as a validated argument type because it has been previously validated as being an argument type that is compatible with the functionality of the function. For example, if the function definition is “upload_file(form: 1098)”, the function name is “upload_file”, the argument category is “form”, and the argument type is integer. Additionally, an argument value may be included in the function definition. An argument value is a specific value of an argument to be passed as input to a function. For example, an argument value of “1098” may refer to the 1098 form. In the function definition “upload_file(form: 1098)”, “1098” is correctly formatted as an integer, as required by the function schema for the “upload_file” function.

FIG. 4 provides another example of a function schema 402. The function schema 402 (representative of function schema 318) provides information about a function that returns the answer to a question from an automated assistant (e.g., help chatbot). Function schema 402 comprises a function name 404 (e.g., “tax_customer_help”), function parameters 414, such as an argument category (e.g., “query”), argument type (e.g., “string”) and other details about the function. Other function parameters include a description of the argument category (e.g., “User query”) and whether the argument is required or optional (e.g., “required: true”). Function schema 402 also includes a function description 406 (e.g., “This function returns the answer to a question from the TurboTax help”), examples 408 of the function definition associated with executing the function (e.g., tax_customer_help(query: “Where do I enter my W-2 1”)), and examples of exclusion queries 410 (such as “I want to talk to an agent” or “I want to talk to a human”) that indicate a user's escalation when interacting with the automated assistant. “Escalation” refers to a type of user interaction with the automated assistant that indicates that the user wishes to interact with a human representative, instead of the automated assistant. This typically occurs when the user does not find the responses from the automated assistant to be helpful or when the tasks being asked of the automated assistant are beyond the capabilities of the automated assistant.

Function schema 402 also comprises configuration features 412 and return features 416. The return features 416 comprise details about what output(s) the function will return after execution. As shown in FIG. 4, return features 416 comprise a name associated with the return (e.g., “answer”), a description of the return (e.g., “Answer to the question”), a type associated with the return (e.g., “domain_object”), and schema reference/storage location details (e.g., “/local/schemas/help.yaml”). The information and features included in the function schema 402 are structured to help an LLM understand how to interact with the function without human intervention.

Returning to FIG. 2, as mentioned above, another input to the validation component 202 is the function plan 208. Function plan 208 is shown comprising function definition 210. It should be appreciated that while function plan 208 is shown with a single function definition 210, a function plan may comprise any number of function definitions. For example, function plan 302 depicted in FIG. 3 comprises a plurality of function definitions (e.g., function definition 304, function definition 306, and function definition 308), which may be examples of function definition 310. When more than one function definition is included in the function plan, the function plan will also comprise a planning strategy that determines the order in which the functions should be executed. By providing the entire function plan 208 to the validation component 202, the validation component 202 is able to validate each function definition in order per the planning strategy, such that dependencies between functions are not affected by hallucinations.

In some aspects, the processing system generates function plan 208. The processing system uses the user query 204 and the function schema 206 to generate function plan 208. For example, the processing system may select, from a plurality of potential functions, a set of functions based on the user query 204. The processing system selects this set of functions based on the function schema 206. For example, the processing system (e.g., an LLM of the processing system) may compare the user query 204 and the function schema 206 to identify appropriate functions. The processing system then constructs function API contracts for each of the selected set of functions according to the function schema 206. For example, the processing system (e.g., the LLM) may extract parameters for a given function, such as a function name, function arguments, and an output of the function, from the function schema 206. The processing system uses these parameters to generate computer code that calls the function. In some examples, as described herein, the processing system configures a series of functions, or a set of functions to be run in parallel, based on inputs and outputs of the set of functions.

The planning strategy can determine a parallel or a series-based execution. The planning strategy takes into consideration (or may be generated based on) dependencies between the different functions, such as if an output from one function corresponds to the input specified for a different function. For example, as illustrated in FIG. 3, the arrows between the function definitions indicate that the order of operation of the functions associated with the function definitions is as follows: function definition 304 will be executed first, followed by the function associated with function definition 306, and then followed by the function associated with the function definition 308. The planning strategy ensures that the functions are executed in the correct order to prevent errors in function outputs or fail states of the different functions.

### Examples of Function Argument Disambiguation

FIG. 5 depicts a flowchart diagram 500 of a method for performing function-argument disambiguation (illustrated in FIG. 2) exemplary of when a hallucination has been detected in the function definition and a corresponding correct feature is included in the user query. In some aspects, the operations of diagram 500 may be performed by a processing system or apparatus such as system 100, system 102, client devices 150, or system 1300. FIG. 5 depicts a set of inputs that are provided to validation component 502 (e.g., validation component 202). The set of inputs includes user query 504 (e.g., user query 204), function schema 506 (e.g., function schema 206) associated with a function that can be called to upload documents to the system, and function definition 508 (e.g., function definition 210) corresponding to function schema 506. User query 504 comprises text-based user input that includes a request for the automated assistant to help with uploading a specific form (e.g., “I need help uploading the 1098 form”). Notably, the user query specifies the form as “1098.” Function schema 506 comprises a function name (e.g., Upload_Function), an argument category (e.g., “Form”) associated with an argument value that can be used in the function, and argument type (e.g., “Integer”) associated with approved formats for the arguments that are used as inputs to the function. Function definition 508 comprises the function name (Upload_Function), argument category (“form”), and argument value (“1099), formatted as follows: “Upload_Function(form: 1099).”

Validation component 502 compares the features of function definition 508 (namely: the function name (e.g., function name 312), argument category, argument type (e.g., argument type 316), and argument value (e.g., argument value 314) with the features of user query 504 (namely: the argument value) and the function schema 506 (namely: the function name (e.g., function name 320), argument category (e.g., argument category 322), and argument type (e.g., argument type 324)). It should be appreciated that validation component 502 is also configured to compare the features of the user query 504 with the features of the function definition 508 and features of the function schema 506 and configured to compare the function schema 506 with the features of the function definition 508 and features of the user query 504. The validation component 502 is configured to check that each of the features of function definition 508 match corresponding features of user query 504 and function schema 506. Here, the argument value (“1099”) found in function definition 508 does not match the argument value (“1098”) found in user query 504. Accordingly, validation check 510 (e.g., validation check 212) returns “false”, indicating that at least one feature does not match. Validation check 510 also returns which hallucination was identified (e.g., “Hallucination: “1099””).

After identifying the hallucination, the system is configured to check if a correct feature corresponding to the hallucination is found in one of the inputs (e.g., check inputs 512). In this case, because the hallucination was associated with the argument value specifying which form will be uploaded, the system will check the user query and function schema to see if the form name was specified in those inputs. Here, because the correct feature (“1098”) is found in user query 504, check inputs 512 returns “True” and extracts (e.g., extract 514) the correct feature (e.g., extracts the correct argument value for the form name). The correct feature (“1098”) extracted from the user query is then used to modify 516 the function definition 508 by replacing the hallucinated feature (e.g., “1099”) with the correct feature (e.g., “1098”). The modified function definition 518 now is formatted as: “Upload_Function(form: 1098)” and is ready to send to execution component 520 to be executed. Execution component 520 executes one or more functions according to the modified function definition 518.

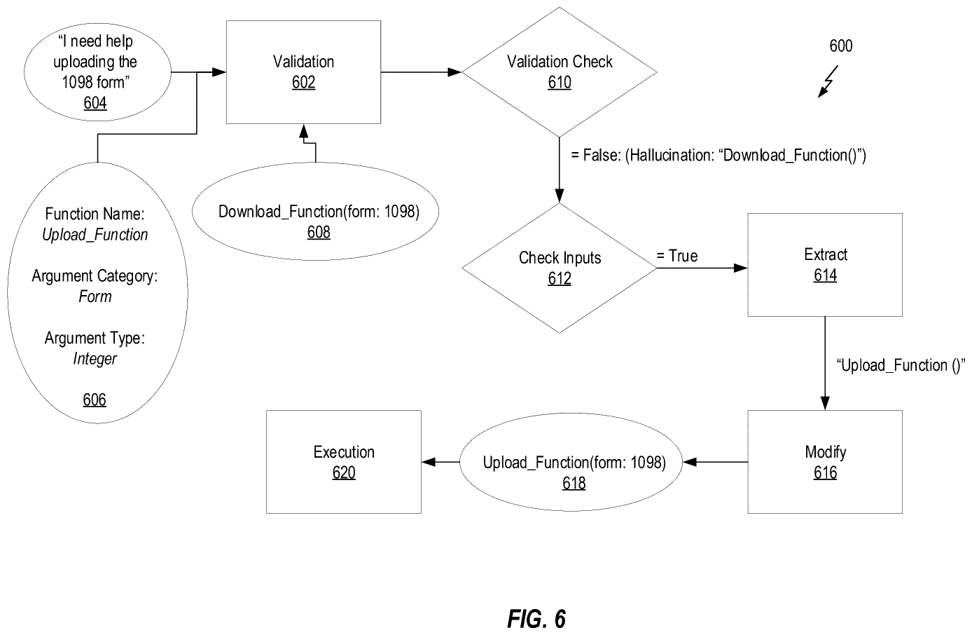

FIG. 6 depicts a flowchart diagram 600 of a method for performing function-argument disambiguation (illustrated in FIG. 2) exemplary of when a hallucination has been detected in the function definition and a corresponding correct feature is included in the function schema. In some aspects, the operations of diagram 600 may be performed by a processing system or apparatus such as system 100, system 102, client devices 150, or system 1300. FIG. 6 depicts a set of inputs that are provided to validation component 602 (e.g., validation component 202). The set of inputs includes user query 604 (e.g., user query 204), function schema 606 (e.g., function schema 206) associated with a function that can be called to upload documents to the system, and function definition 608 (e.g., function definition 210) corresponding to function schema 606. User query 604 comprises text-based user input that includes a request for the automated assistant to help with uploading a specific form (e.g., “I need help uploading the 1098 form”). Notably, the user query specifies the form as “1098.” Function schema 606 comprises a function name (e.g., Upload_Function), an argument category (e.g., “Form”) associated with an argument value that can be used in the function, and argument type (e.g., “Integer”) associated with approved formats for the arguments that are used as inputs to the function. Function definition 608 comprises the function name (Download_Function), argument category (“form”), and argument value (“1098), formatted as follows: “Download_Function(form: 1098).”

Validation component 602 compares the features of function definition 608, namely: the function name (e.g., function name 312), argument category, argument type (e.g., argument type 316), and argument value (e.g., argument value 314), with the features of user query 604, namely: the argument value, and the function schema 606, namely: the function name (e.g., function name 320), argument category (e.g., argument category 322), and argument type (e.g., argument type 324). The validation component 602 is configured to check that each of the features of function definition 608 match corresponding features of user query 604 and function schema 606. Here, the function name (“Download_Function”) found in function definition 608 does not match the function name (“Upload_Function”) found in function schema 606. Accordingly, validation check 610 (e.g., validation check 212) returns “false”, indicating that at least one feature does not match. Validation check 610 also returns which hallucination was identified (e.g., “Hallucination: “Download_Function( )””).

After identifying the hallucination, the system (e.g., system 100, system 102, client device 150, or system 1300) is configured to check if a correct feature corresponding to the hallucination is found in one of the inputs (e.g., check inputs 612). In this case, because the hallucination was associated with the function name that will be used in providing a response to the user query, the system will check the user query 604 and function schema 606 to see if the function name was specified in those inputs. Here, because the correct feature (“Upload_Function”) is found in function schema 606, check inputs 512 returns “True” and extracts (e.g., extract 614) the correct feature (e.g., extracts the correct function name). The correct feature (“Upload_Function”) extracted from the function schema is then used to modify 616 the function definition 608 by replacing the hallucinated feature (e.g., “Download_Function”) with the correct feature (e.g., “Upload_Function”). The modified function definition 618 now is formatted as: “Upload_Function(form: 1098)” and is ready to send to execution component 620 (e.g., execution component 216) to be executed.

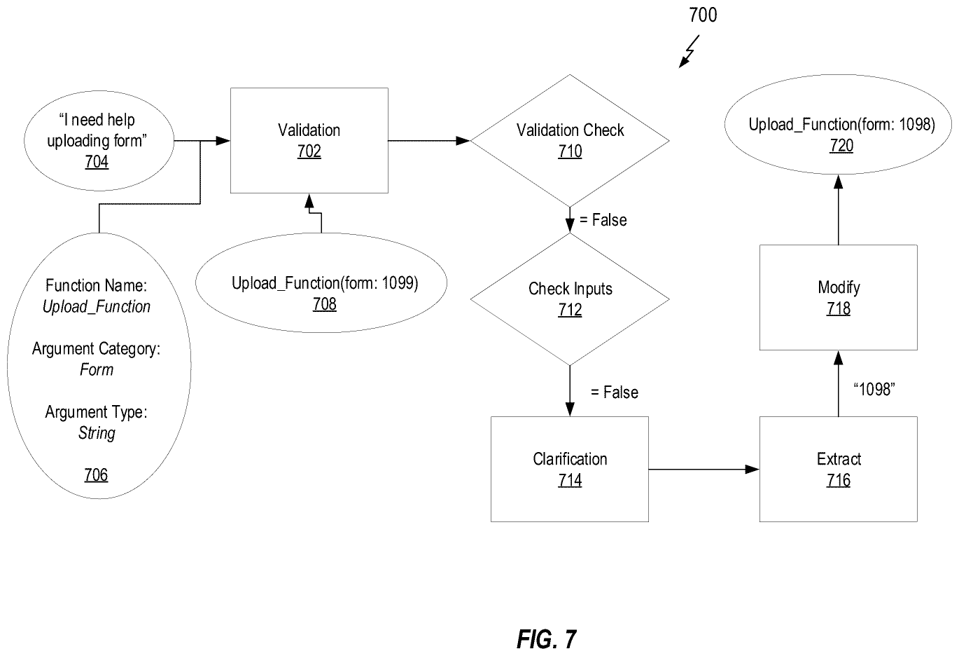

FIG. 7 depicts a flowchart diagram 700 of a method for performing function-argument disambiguation (illustrated in FIG. 2) exemplary of when a hallucination has been detected in the function definition and a corresponding correct feature is included in the user query. In some aspects, the operations of diagram 700 may be performed by a processing system or apparatus such as system 100, system 102, client devices 150, or system 1300. FIG. 7 depicts a set of inputs that are provided to validation component 702 (e.g., validation component 202). The set of inputs includes user query 704 (e.g., user query 204), function schema 706 (e.g., function schema 206) associated with a function that can be called to upload documents to the system, and function definition 708 (e.g., function definition 210) corresponding to function schema 706. User query 704 comprises text-based user input that includes a request for the automated assistant to help with uploading a specific form (e.g., “I need help uploading form”). Function schema 706 comprises a function name (e.g., Upload_Function), an argument category (e.g., “Form”) associated with an argument value that can be used in the function, and argument type (e.g., “Integer”) associated with approved formats for the arguments that are used as inputs to the function. Function definition 708 comprises the function name (Upload_Function), argument category (“form”), and argument value (“1099), formatted as follows: “Upload_Function(form: 1099).”

Validation component 702 compares the features of function definition 708, namely: the function name (e.g., function name 312), argument category, argument type (e.g., argument type 316), and argument value (e.g., argument value 314), with the features of user query 704, namely: the argument value, and the function schema 706, namely: the function name (e.g., function name 320), argument category (e.g., argument category 322), and argument type (e.g., argument type 324). The validation component 702 is configured to check that each of the features of function definition 708 match corresponding features of user query 704 and function schema 706. Here, the argument value (“1099”) found in function definition 708 does not match the argument value (“null”) found in user query 704. The argument value found in the user query 704 is a null value because no particular form was specified in the user query. Instead, the user query requests help with “form” but doesn't actually indicate which form the user would like help with. Accordingly, validation check 710 (e.g., validation check 212) returns “false”, indicating that at least one feature does not match. Validation check 710 also returns which hallucination was identified (e.g., “Hallucination: “1099”) in the function definition 708.

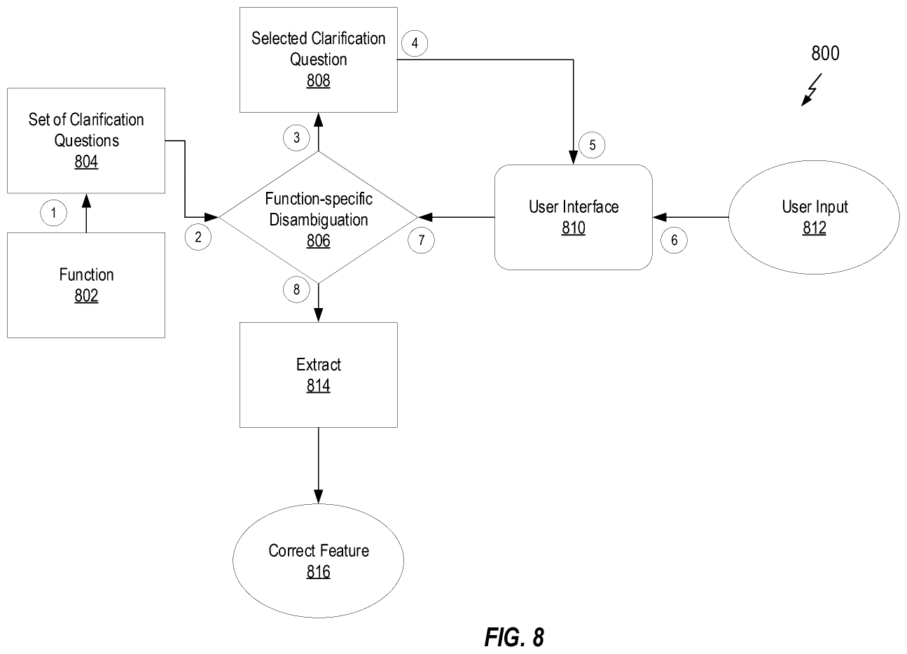

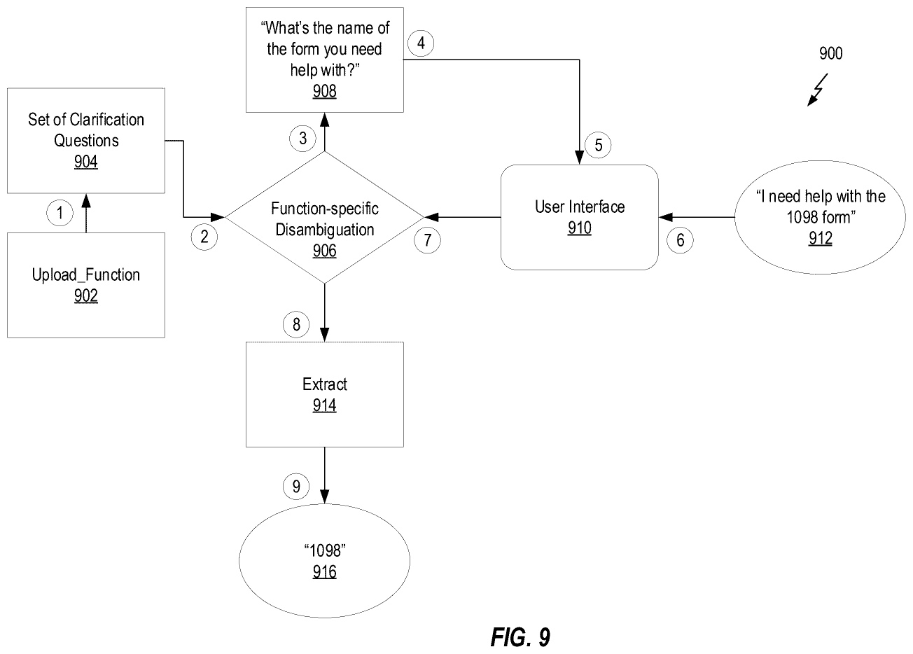

After identifying the hallucination, the system is configured to check if a correct feature corresponding to the hallucination is found in one of the inputs (e.g., check inputs 712). In this case, because the hallucination was associated with the argument value specifying which form will be uploaded, the system will check the user query and function schema to see if the form name was specified in those inputs. Here, because the correct feature is not found in user query 704, check inputs 712 returns “False” and an indication to perform further function argument disambiguation, including a clarification process (e.g., clarification 714, described in more detail with reference to FIG. 8-9) to obtain the correct feature.

After obtaining the correct feature, the system extracts (e.g., at 718) the correct feature (e.g., extracts the correct argument value for the form name). The correct feature (“1098”) extracted from additional user input received through the clarification process is then used to modify 718 the function definition 708 by replacing the hallucinated feature (e.g., “1099”) with the correct feature (e.g., “1098”). The modified function definition 720 now is formatted as: “Upload_Function(form: 1098)” and is ready to be executed. Subsequently, the modified function definition 720 is then transmitted to the execution component 216, wherein the modified function definition 720 is executed by the execution component 216.

FIG. 8, described in reference to components and elements of FIG. 7, depicts a flowchart diagram of a method for the clarification process illustrated as “clarification 714” in FIG. 7. In some aspects, the operations of diagram 800 may be performed by a processing system or apparatus such as system 100, system 102, client devices 150, or system 1300. It should be noted that clarification 714 can also be referred to as function-specific disambiguation, which is a type of function argument disambiguation that is implemented when the correct feature corresponding to the hallucination is not found in the inputs provided to validation component 702. For example, as illustrated in FIG. 8, function 802 is identified based on being associated with the function corresponding to function schema 706. The system is then configured to access a database of clarification questions. The database of clarification questions may be indexed as sets of clarification questions. Each set of clarification questions corresponds to a particular function of a plurality of functions that can be called by the system to generate responses to user queries. The system identifies a set of clarification questions 804 that corresponds to function 802 (step 1).

Function 802 and set of clarification questions 804 are provided as inputs to the function-specific disambiguation 806 (step 2). In some instances, the user query 704 and function schema 706 are also provided as inputs to function-specific disambiguation 806 to provide additional context for the present task of obtaining the correct feature. Function-specific disambiguation 806 is configured to select a clarification question from the set of clarification questions (step 3). The selected clarification question 808 is configured to prompt a user to provide additional user input that includes a correct feature that can be used to correct the hallucination detected in function definition 708 (e.g., function definition 210). The selected clarification question 808 is selected based on being identified as the clarification question that is most likely to illicit the correct feature from the user out of the different clarification questions included in the set of clarification questions 804. In some instances, function-specific disambiguation 806 may select several different clarification questions from the set of clarification questions 804 to present to the user.

The selected clarification question 808 is transmitted (step 4) to a user interface 810 (e.g., user interface 152) configured to display (step 5) the selected clarification question 808. The user interface is further configured to receive (step 6) additional user input 812 from the user in response to the selected clarification question 808. After receiving the additional user input 812 from the user interface 810 (step 7), function-specific disambiguation 806 determines whether a correct feature corresponding the hallucination is found in the additional user input 812. If the correct feature is not found, function-specific disambiguation 806 may return to step 3 and select another clarification question from the set of clarification questions 804 in order to prompt the user with a different clarification question to provide the correct feature needed to execute the function properly.

If the correct feature is found in the additional user input 812 (step 8), the system is configured to extract 814 the correct feature 816 from the additional user input 812. This correct feature 816 is then used to modify the function definition 708 by replacing the hallucination with the correct feature. The modified function definition 720 is then ready to be transmitted to the execution component 216 to be executed as part of the function plan 208. Subsequently, the modified function definition 720 is then transmitted to the execution component 216, wherein the modified function definition 720 is executed by the execution component 216.

FIG. 9, described in reference to components and elements of FIG. 7, depicts a flowchart diagram of an example of function-specific disambiguation illustrated in FIG. 8. In some aspects, the operations of diagram 900 may be performed by a processing system or apparatus such as system 100, system 102, client devices 150, or system 1300. For example, as illustrated in FIG. 9, function 902 (e.g., “Upload_Function”) is identified based on being associated with the function corresponding to function schema 706 for assisting a user in uploading a form. The system identifies a set of clarification questions 904 (e.g., set of clarification questions 804) that corresponds to function 902 (step 1).

Function 902 and set of clarification questions 904 are provided as inputs to function-specific disambiguation 906 (e.g., function-specific disambiguation 806) (step 2). Function-specific disambiguation 906 is configured to select a clarification question from the set of clarification questions (step 3). The selected clarification question 908 (e.g., “What's the name of the form you need help with?”) (e.g., selected clarification question 808) is configured to prompt a user to provide additional user input that includes a correct feature (e.g., the correct form name) that can be used to correct the hallucination detected in function definition 708 (e.g., function definition 210). The selected clarification question 908 is selected based on being identified as the clarification question that is most likely to elicit the correct form name from the user out of the different clarification questions included in the set of clarification questions 904.

The selected clarification question 908 is transmitted (step 4) to a user interface 910 (e.g., user interface 152) configured to display (step 5) the selected clarification question 908 and receive (step 6) additional user input 912 (e.g., “I need help with the 1098 form”) (e.g., additional user input 812) from the user in response to the selected clarification question 808. After receiving the additional user input 912 from the user interface 910 (step 7), function-specific disambiguation 906 determines whether a correct feature corresponding the hallucination is found in the additional user input 912.

Here, the correct feature is found in the additional user input 912 (step 8). Accordingly, the system is configured to extract 914 (e.g., extract 814) the correct feature 916 (e.g., correct feature 816) (e.g., “1098”) from the additional user input 912. This correct feature 916 is then used to modify the function definition 708 by replacing the hallucination (e.g., “1099”) with the correct feature (e.g., “1098”). The modified function definition 720 (e.g., “Upload_Function(form: 1098”) is now ready to be executed. Subsequently, the modified function definition 720 is then transmitted to the execution component 216, wherein the modified function definition 720 is executed by the execution component 216.

### Example Operations for Validating Function Plans

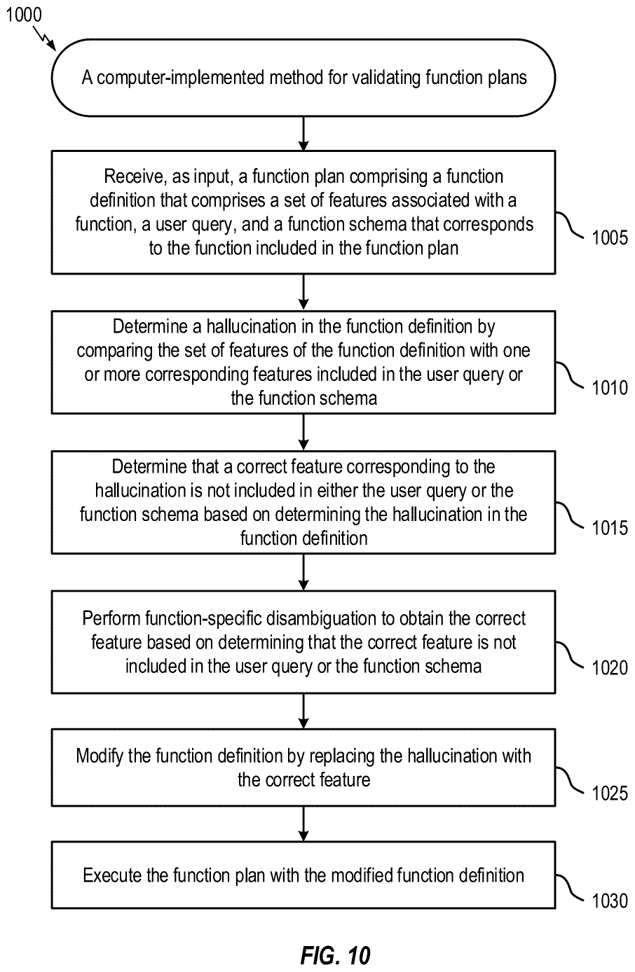

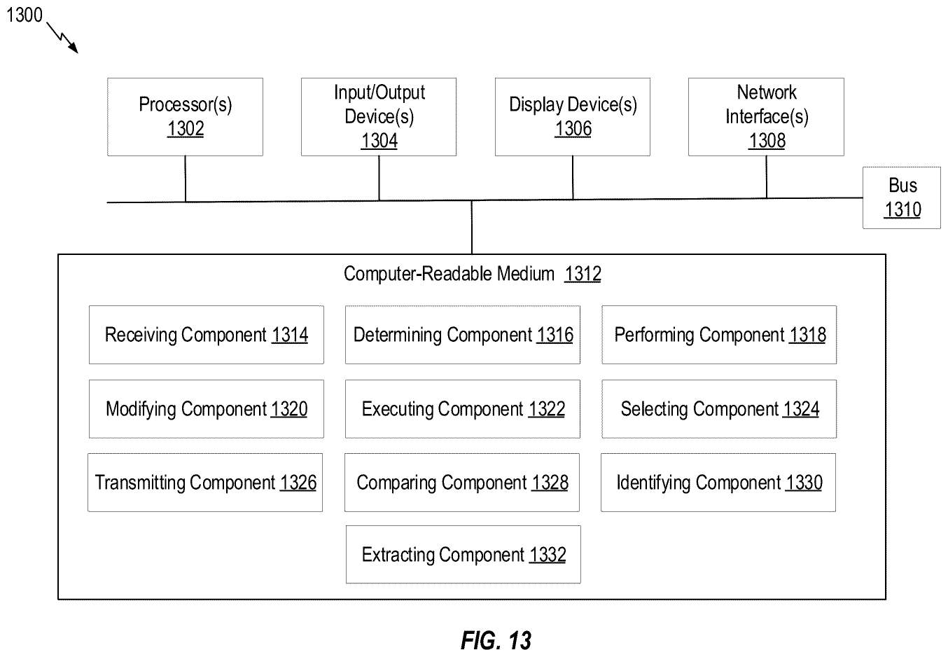

FIG. 10 shows a method 1000 for validating function plans by a processing system, such as processing system 1300 of FIG. 13.

Method 1000 begins at block 1005 with receiving, as input, a function plan (e.g., function plan 208) comprising a function definition (e.g., function definition 210) that comprises a set of features associated with a function (e.g., function 802), a user query (e.g., user query 204), and a function schema (e.g., function schema 206) that corresponds to the function included in the function plan. By providing each of the aforementioned inputs to the validation component (e.g., validation component 202), the validation component is able to perform a comparison between the different inputs and their corresponding features.

Method 1000 then proceeds to block 1010 with determining (e.g., validation component 202) a hallucination in the function definition by comparing the set of features of the function definition with one or more corresponding features included in the user query or the function schema. By comparing corresponding features in the different inputs, the validation component is able to quickly and efficiently determine whether there are any hallucinations in any of the different inputs. Furthermore, because this comparison and determination is rule-based, the method 1000 beneficially avoids introducing further hallucinations during this validation stage.

Method 1000 then proceeds to block 1015 with, based on determining the hallucination in the function definition, determining (e.g., check inputs 512, check inputs 612, check inputs 712) that a correct feature corresponding to the hallucination is not included in either the user query or the function schema. In some instances, the correct feature is already included in one of the previously provided inputs. Thus, the method 1000 beneficially checks to see if the correct feature is already included and can proceed to extracting the feature directly. If the correct feature is not included, the method 1000 can proceed to performing additional steps (e.g., clarification or function-argument disambiguation) to obtain the correct feature. Thus, by checking the inputs at this stage, the method 1000 avoids incurring further drain on computational resources by only performing function-argument disambiguation when needed.

Method 1000 then proceeds to block 1020 with, based on determining that the correct feature is not included in the user query or the function schema, performing function argument disambiguation (e.g., function argument disambiguation 214) to obtain (e.g., extract 514, extract 614, extract 716) the correct feature.

Method 1000 then proceeds to block 1025 with modifying (e.g., modify 516, modify 616, modify 718) the function definition by replacing the hallucination with the correct feature. By fixing hallucinations in the function plan, the method is able to prevent errors in executing the functions. By fixing current errors and preventing further ones, the function plan execution is improved, thereby improving the final response that is presented to the user. This allows for high quality and accurate responses to be presented to the users which improves the user experience while interacting with the automated assistant. Additionally, because hallucinations are caught prior to executing any functions, the method 1000 is able to process the user query faster and more efficiently, without having to employ additional error mitigation techniques.

Method 1000 then proceeds to block 1030 with executing (e.g., execution component 216) the function plan with the modified function definition. By performing plan validation prior to executing any of the functions in the function plan, the method ensures that each function is properly defined in the function plan with the correct function name, argument value, and argument type. This helps to ensure functions in the function plan are executed correctly and provide accurate results that will be used in generating a final output that will be presented to the user in response to the user query that was submitted. This reduces drain on computational resources such as processor or memory usage that would otherwise occur if the results and corresponding final output are inaccurate, thus requiring further correction or additional output generation.

In some aspects, the function plan comprises a second function definition associated with a second function, wherein block 1030 includes, based on determining that a second hallucination does not exist in the second function definition, executing the function plan without modifying the second function definition.

In some aspects, block 1020 includes: selecting a clarification question from a set of clarification questions corresponding to the function, wherein the clarification question is configured to prompt a user to provide the correct feature; transmitting the clarification question to a user interface; receiving user input comprising the correct feature based on the clarification question; and extracting the correct feature from the user input.

In some aspects, the set of clarification questions is pre-defined.

In some aspects, the function plan comprises a second function definition associated with a second function, wherein the second function definition comprises a second hallucination, and the method 1000 further comprises: based on determining that a second correct feature is included the user query or a second function schema associated with the second function definition, extracting the second correct feature from the user query or the second function schema; and modifying the second function definition by replacing the second hallucination with the second correct feature.

In some aspects, block 1010 includes determining that at least one feature of the function definition does not match a corresponding feature included in either the user query or the function schema.

In some aspects, the set of features comprises a first function name of the function associated with the function plan, an argument value, and an argument type associated with the argument value.

In some aspects, the function schema corresponding to the function comprises a second function name, an argument category, and at least one validated argument type associated with the argument category.

In some aspects, determining that at least one feature of the function definition does not match at least one corresponding feature included in either the user query or the function schema comprises one or more of: determining that the first function name included in the function definition does not match the second function name specified in the function schema; determining that the argument value included in the function definition does not correspond to the argument category specified in the function schema; or determining that the argument value included in the function definition does not match a second argument value included in the user query.

In some aspects, determining that at least one feature of the function definition does not match at least one corresponding feature included in either the user query or the function schema comprises determining that the user query does not include a particular argument value that corresponds to the argument value included in the function definition.

In some aspects, the function plan comprises a plurality of function definitions and a planning strategy that determines an order of execution of the plurality of function definitions.

In some aspects, method 1000, or any aspect related to it, may be performed by an apparatus or processing system, such as processing system 1300 of FIG. 13, which includes various components operable, configured, or adapted to perform the method 1000. Processing system 1300 is described below in further detail.

Note that FIG. 10 is just one example of a method, and other methods including fewer, additional, or alternative operations are possible consistent with this disclosure.

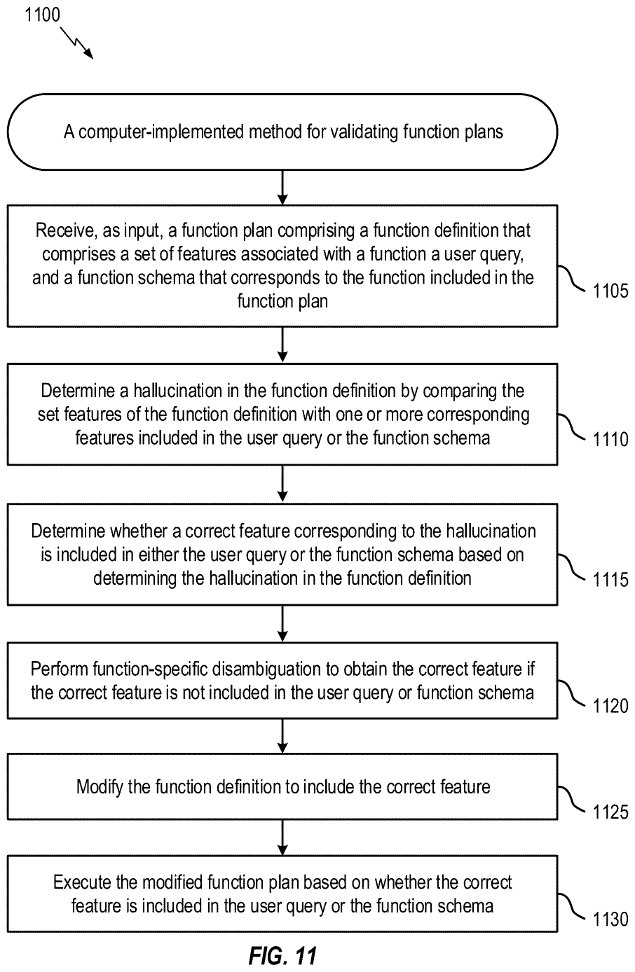

FIG. 11 shows a method 1100 for validating function plans by a processing system, such as processing system 1300 of FIG. 13.

Method 1100 begins at block 1105 with receiving, as input, a function plan (e.g., function plan 208) comprising a function definition (e.g., function definition 210) that comprises a set of features associated with a function a user query (e.g., user query 204), and a function schema (e.g., function schema 206) that corresponds to the function included in the function plan. By providing each of the aforementioned inputs to the validation component (e.g., validation component 202), the validation component is able to perform a comparison between the different inputs and their corresponding features.

Method 1100 then proceeds to block 1110 with determining (e.g., validation component 202) a hallucination in the function definition by comparing the set features of the function definition with one or more corresponding features included in the user query or the function schema. By comparing corresponding features in the different inputs, the validation component is able to quickly and efficiently determine whether there are any hallucinations in any of the different inputs. Furthermore, because this comparison and determination is rule-based, the method 1100 beneficially avoids introducing further hallucinations during this validation stage.

Method 1100 then proceeds to block 1115 with, based on determining the hallucination in the function definition, determining (e.g., check inputs 512, check inputs 612, check inputs 712) whether a correct feature corresponding to the hallucination is included in either the user query or the function schema. In some instances, the correct feature is already included in one of the previously provided inputs. Thus, the method 1100 beneficially checks to see if the correct feature is already included and can proceed to extracting the feature directly. If the correct feature is not included, the method 1100 can proceed to performing additional steps (e.g., clarification or function-argument disambiguation) to obtain the correct feature. Thus, by checking the inputs at this stage, the method 1100 avoids incurring further drain on computational resources by only performing function-argument disambiguation when needed.

Method 1100 then proceeds to block 1120 with, if the correct feature is not included in the user query or function schema, performing function-specific disambiguation (e.g., function-specific disambiguation 806) to obtain the correct feature (e.g., correct feature 816). By performing function-specific disambiguation at this stage, the method 1100 is able to obtain the correct feature from additional user input when the correct feature is not already included or present in one of the previously provided inputs. Thus, function-specific disambiguation allows the method 1100 to obtain the correct feature where it previously would not have been able to determine an accurate correction to the hallucination. Furthermore, by prompting the user, during function-specific disambiguation, to provide the additional user input, the method 1100 is able to verify the original intent of the user when they submitted the original user query. This ensures that the response to the user generated by performing method 1100 is accurate and helpful based on the user query and the additional user input.

Method 1100 then proceeds to block 1125 with modifying (e.g., modify 718) the function definition to include the correct feature. By fixing hallucinations in the function plan, the method 1100 is able to prevent errors in executing the functions. By fixing current errors and preventing further ones, the function plan execution is improved, thereby improving the final response that is presented to the user. This allows for high quality and accurate responses to be presented to the users which improves the user experience while interacting with the automated assistant. Additionally, because hallucinations are caught prior to executing any functions, the method 1100 is able to process the user query faster and more efficiently, without having to employ additional error mitigation techniques.

Method 1100 then proceeds to block 1130 with executing (e.g., execution component 216) the modified function plan based on whether the correct feature is included in the user query or the function schema. By performing plan validation prior to executing any of the functions in the function plan, the method 1100 ensures that each function is properly defined in the function plan with the correct function name, argument value, and argument type. This helps to ensure functions in the function plan are executed correctly and provide accurate results that will be used in generating a final output that will be presented to the user in response to the user query that was submitted. This avoids any unnecessary drain on computational resources such as processor or memory usage that would otherwise be incurred if the results and corresponding final output are inaccurate, thus involving further correction or additional output generation.

In some aspects, method 1100, or any aspect related to it, may be performed by an apparatus, such as processing system 1300 of FIG. 13, which includes various components operable, configured, or adapted to perform the method 1100. Processing system 1300 is described below in further detail.

Note that FIG. 11 is just one example of a method, and other methods including fewer, additional, or alternative operations are possible consistent with this disclosure.

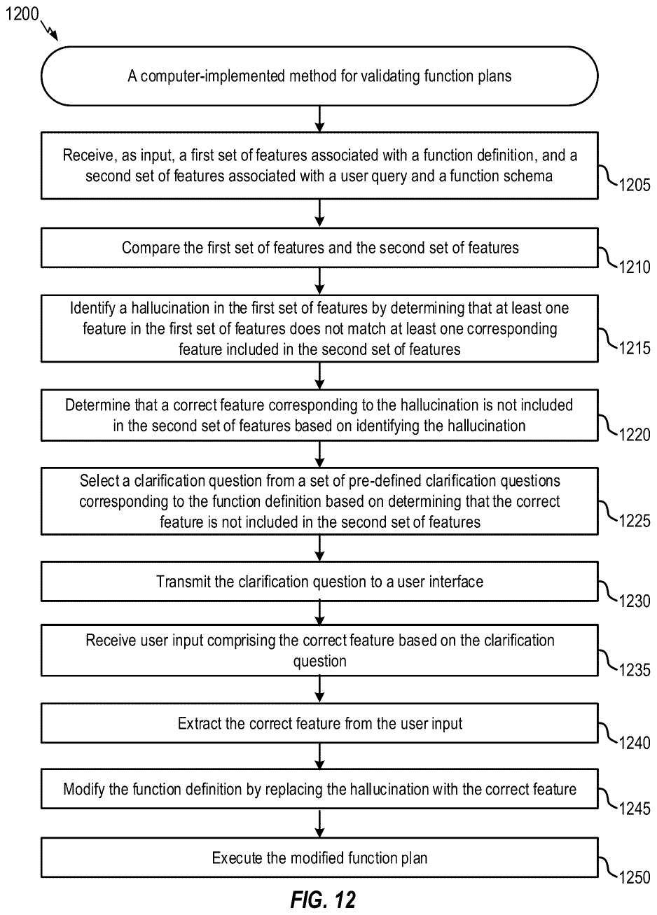

FIG. 12 shows a method 1200 for validating function plans by a processing system, such as processing system 1300 of FIG. 13.

Method 1200 begins at block 1205 with receiving, as input, a first set of features associated with a function definition (e.g., function definition 210), and a second set of features associated with a user query (e.g., user query 204) and a function schema (e.g., function schema 206). By providing each of the aforementioned inputs to the validation component (e.g., validation component 202), the validation component is able to perform a comparison between the different inputs and their corresponding features.

Method 1200 then proceeds to block 1210 with comparing (e.g., validation component 202) the first set of features and the second set of features. By comparing corresponding features in the different inputs, the validation component is able to quickly and efficiently determine whether there are any hallucinations in any of the different inputs. Furthermore, because this comparison and determination is rule-based, the method 1200 beneficially avoids introducing further hallucinations during this validation stage.

Method 1200 then proceeds to block 1215 with identifying a hallucination in the first set of features by determining that at least one feature in the first set of features does not match at least one corresponding feature included in the second set of features. Notably, it is important that the corresponding features match between the different inputs to ensure that the function plan can both be executed correctly and efficiently and to ensure that the function plan will yield a user response that is relevant and helpful to the user query provided by the user.

Method 1200 then proceeds to block 1220 with, based on identifying the hallucination, determining (e.g., check inputs 512, check inputs 612, check inputs 712) that a correct feature corresponding to the hallucination is not included in the second set of features. In some instances, the correct feature is already included in one of the previously provided inputs. Thus, the method 1200 beneficially checks to see if the correct feature is already included and can proceed to extracting the feature directly. If the correct feature is not included, the method 1200 can proceed to performing additional steps (e.g., clarification or function-argument disambiguation) to obtain the correct feature. Thus, by checking the inputs at this stage, the method 1200 avoids incurring further drain on computational resources by only performing function-argument disambiguation when needed.

Method 1200 then proceeds to block 1225 with, based on determining that the correct feature is not included in the second set of features, selecting a clarification question (e.g., selected clarification question 808) from a set of pre-defined clarification questions (e.g., set of clarification questions 804) corresponding to the function definition, wherein the clarification question is configured to prompt a user to provide the correct feature. Because the method 1200 is beneficially equipped with function-specific clarification questions, the method 1200 is able to quickly and efficiently identify missing information in the user query and obtain any additional information that is needed to properly execute the function plan. This ensures that the results returned from executing the function plan are relevant and accurate with respect to what the user originally intended when submitting their user query.

Method 1200 then proceeds to block 1230 with transmitting the clarification question to a user interface (e.g., user interface 810). By transmitting the clarification question to the user interface, a user is able to view and interact with the clarification question by providing additional user input in response to the clarification question.

Method 1200 then proceeds to block 1235 with receiving user input (e.g., additional user input 812) comprising the correct feature based on the clarification question. By performing function-specific disambiguation at this stage, the method 1200 is able to obtain the correct feature from additional user input when the correct feature is not already included or present in one of the previously provided inputs. Thus, function-specific disambiguation allows the method 1200 to obtain the correct feature where it previously would not have been able to determine an accurate correction to the hallucination. Furthermore, by prompting the user, during function-specific disambiguation, to provide the additional user input, the method 1200 is able to verify the original intent of the user when they submitted the original user query. This ensures that the response to the user generated by the method 1200 is accurate and helpful based on the user query and the additional user input.

Method 1200 then proceeds to block 1240 with extracting (e.g., extract 814) the correct feature (e.g., correct feature 816) from the user input. By extracting the correct feature from the additional user input, the method 1200 is able to use this correct feature to modify the function definition in order to correct the hallucination found in the function definition.

Method 1200 then proceeds to block 1245 with modifying (e.g., modify 718) the function definition by replacing the hallucination with the correct feature. By fixing hallucinations in the function plan, the method 1200 is able to prevent errors in executing the functions. By fixing current errors and preventing further ones, the function plan execution is improved, thereby improving the final response that is presented to the user. This allows for high quality and accurate responses to be presented to the users which improves the user experience while interacting with the automated assistant. Additionally, because hallucinations are caught prior to executing any functions, the method 1200 is able to process the user query faster and more efficiently, without having to employ additional error mitigation techniques.

Method 1200 then proceeds to block 1250 with executing (e.g., execution component 216) the modified function plan. By performing plan validation prior to executing any of the functions in the function plan, the method 1200 ensures that each function is properly defined in the function plan with the correct function name, argument value, and argument type. This helps to ensure functions in the function plan are executed correctly and provide accurate results that will be used in generating a final output that will be presented to the user in response to the user query that was submitted. This avoids any unnecessary drain on computational resources such as processor or memory usage that would otherwise be required if the results and corresponding final output are inaccurate, thus requiring further correction or additional output generation.

In some aspects, method 1200, or any aspect related to it, may be performed by an apparatus, such as processing system 1300 of FIG. 13, which includes various components operable, configured, or adapted to perform the method 1200. Processing system 1300 is described below in further detail.

Note that FIG. 12 is just one example of a method, and other methods including fewer, additional, or alternative operations are possible consistent with this disclosure.

### Example Processing System for Validating Function Plans

FIG. 13 depicts an example processing system 1300 configured to perform various aspects described herein, including, for example, method 1000 as described above with respect to FIG. 10, method 1100 as described above with respect to FIG. 11, and/or method 1200 as described above with respect to FIG. 12.

Processing system 1300 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1300 includes one or more processors 1302, one or more input/output devices 1304, one or more display devices 1306, one or more network interfaces 1308 through which processing system 1300 is connected to one or more networks (e.g., a local network, an intranet, the Internet, or any other group of processing systems communicatively connected to each other), and computer-readable medium 1312. In the depicted example, the aforementioned components are coupled by a bus 1310, which may generally be configured for data exchange amongst the components. Bus 1310 may be representative of multiple buses, while only one is depicted for simplicity.

Processor(s) 1302 are generally configured to retrieve and execute instructions stored in one or more memories, including local memories like computer-readable medium 1312, as well as remote memories and data stores. Similarly, processor(s) 1302 are configured to store application data residing in local memories like the computer-readable medium 1312, as well as remote memories and data stores. More generally, bus 1310 is configured to transmit programming instructions and application data among the processor(s) 1302, display device(s) 1306, network interface(s) 1308, and/or computer-readable medium 1312. In certain embodiments, processor(s) 1302 are representative of a one or more central processing units (CPUs), graphics processing unit (GPUs), tensor processing unit (TPUs), accelerators, and other processing devices.

Input/output device(s) 1304 may include any device, mechanism, system, interactive display, and/or various other hardware and software components for communicating information between processing system 1300 and a user of processing system 1300. For example, input/output device(s) 1304 may include input hardware, such as a keyboard, touch screen, button, microphone, speaker, and/or other device for receiving inputs from the user and sending outputs to the user.

Display device(s) 1306 may generally include any sort of device configured to display data, information, graphics, user interface elements, and the like to a user. For example, display device(s) 1306 may include internal and external displays such as an internal display of a tablet computer or an external display for a server computer or a projector. Display device(s) 1306 may further include displays for devices, such as augmented, virtual, and/or extended reality devices. In various embodiments, display device(s) 1316 may be configured to display a graphical user interface.

Network interface(s) 1308 provide processing system 1300 with access to external networks and thereby to external processing systems. Network interface(s) 1308 can generally be any hardware and/or software capable of transmitting and/or receiving data via a wired or wireless network connection. Accordingly, network interface(s) 1308 can include a communication transceiver for sending and/or receiving any wired and/or wireless communication.

Computer-readable medium 1312 may be a volatile memory, such as a random access memory (RAM), or a nonvolatile memory, such as nonvolatile random access memory (NVRAM), or the like. In this example, computer-readable medium 1312 includes receiving component 1314, determining component 1316, performing component 1318, modifying component 1320, executing component 1322, selecting component 1324, transmitting component 1326, comparing component 1328, identifying component 1330, and extracting component 1332. Processing of the components 1314-1326 may enable and cause the processing system 1300 to perform: the method 1000 as described above with respect to FIG. 10, or any aspect related to it; the method 1100 as described above with respect to FIG. 11, or any aspect related to it; and/or method 1200 as described above with respect to FIG. 12, or any aspect related to it.

In certain embodiments, receiving component 1314 is configured to receive, as input, a function plan comprising a function definition that comprises a set of features associated with a function, a user query, and a function schema that corresponds to the function included in the function plan, as described in FIG. 10 with reference to block 1005. In certain embodiments, determining component 1316 is configured to determine a hallucination in the function definition by comparing the set of features of the function definition with one or more corresponding features included in the user query or the function schema, as described in FIG. 10 with reference to block 1010. In certain embodiments, determining component 1316 is configured to determine that a correct feature corresponding to the hallucination is not included in either the user query or the function schema based on determining the hallucination in the function definition, as described in FIG. 10 with reference to block 1015. In certain embodiments, performing component 1318 is configured to perform function-specific disambiguation to obtain the correct feature based on determining that the correct feature is not included in the user query or the function schema, as described in FIG. 10 with reference to block 1020. In certain embodiments, modifying component 1320 is configured to modify the function definition by replacing the hallucination with the correct feature, as described in FIG. 10 with reference to block 1025. In certain embodiments, executing component 1322 is configured to execute the function plan with the modified function definition, as described in FIG. 10 with reference to block 1030.

In certain embodiments, receiving component 1314 is configured to receive, as input, a function plan comprising a function definition that comprises a set of features associated with a function a user query, and a function schema that corresponds to the function included in the function plan, as described in FIG. 11 with reference to block 1105. In certain embodiments, determining component 1316 is configured to determine a hallucination in the function definition by comparing the set features of the function definition with one or more corresponding features included in the user query or the function schema, as described in FIG. 11 with reference to block 1110. In certain embodiments, determining component 1316 is configured to determine whether a correct feature corresponding to the hallucination is included in either the user query or the function schema based on determining the hallucination in the function definition, as described in FIG. 11 with reference to block 1115. In certain embodiments, performing component 1318 is configured to perform function-specific disambiguation to obtain the correct feature if the correct feature is not included in the user query or function schema, as described in FIG. 11 with reference to block 1120. In certain embodiments, modifying component 1320 is configured to modify the function definition to include the correct feature, as described in FIG. 11 with reference to block 1125. In certain embodiments, executing component 1322 is configured to execute the modified function plan based on whether the correct feature is included in the user query or the function schema, as described in FIG. 11 with reference to block 1130.

In certain embodiments, receiving component 1314 is configured to receive, as input, a first set of features associated with a function definition, and a second set of features associated with a user query and a function schema, as described in FIG. 12 with reference to block 1205. In certain embodiments, comparing component 1328 is configured to compare the first set of features and the second set of features, as described in FIG. 12 with reference to block 1210. In certain embodiments, identifying component 1330 is configured to identify a hallucination in the first set of features by determining that at least one feature in the first set of features does not match at least one corresponding feature included in the second set of features, as described in FIG. 12 with reference to block 1215. In certain embodiments, determining component 1316 is configured to determine that a correct feature corresponding to the hallucination is not included in the second set of features based on identifying the hallucination, as described in FIG. 12 with reference to block 1220. In certain embodiments, selecting component 1324 is configured to select a clarification question from a set of pre-defined clarification questions corresponding to the function definition based on determining that the correct feature is not included in the second set of features, wherein the clarification question is configured to prompt a user to provide the correct feature, as described in FIG. 12 with reference to block 1225. In certain embodiments, transmitting component 1326 is configured to transmit the clarification question to a user interface, as described in FIG. 12 with reference to block 1230. In certain embodiments, receiving component 1314 is configured to receive user input comprising the correct feature based on the clarification question, as described in FIG. 12 with reference to block 1235. In certain embodiments, extracting component 1332 is configured to extract the correct feature from the user input, as described in FIG. 12 with reference to block 1240. In certain embodiments, modifying component 1320 is configured to modify the function definition by replacing the hallucination with the correct feature, as described in FIG. 12 with reference to block 1245. In certain embodiments, executing component 1322 is configured to execute the modified function plan, as described in FIG. 12 with reference to block 1250.

Note that FIG. 13 is just one example of a processing system consistent with aspects described herein, and other processing systems having additional, alternative, or fewer components are possible consistent with this disclosure.

### EXAMPLE CLAUSES

Implementation examples are described in the following numbered clauses:

### Clause 1

A computer-implemented method for validating function plans, comprising: receiving, as input, a function plan comprising a function definition that comprises a set of features associated with a function, a user query, and a function schema that corresponds to the function included in the function plan; determining a hallucination in the function definition by comparing the set of features of the function definition with one or more corresponding features included in the user query or the function schema; based on determining the hallucination in the function definition, determining that a correct feature corresponding to the hallucination is not included in either the user query or the function schema; based on determining that the correct feature is not included in the user query or the function schema, performing function-specific disambiguation to obtain the correct feature; modifying the function definition by replacing the hallucination with the correct feature; and executing the function plan with the modified function definition.

### Clause 2

The computer-implemented method of Clause 1, wherein the function plan comprises a second function definition associated with a second function, wherein executing the function plan further comprises, based on determining that a second hallucination does not exist in the second function definition, executing the function plan without modifying the second function definition.

### Clause 3

The computer-implemented method of any one of Clauses 1-2, wherein performing function specific disambiguation to obtain the correct feature comprises: selecting a clarification question from a set of clarification questions corresponding to the function, wherein the clarification question is configured to prompt a user to provide the correct feature; transmitting the clarification question to a user interface; receiving user input comprising the correct feature based on the clarification question; and extracting the correct feature from the user input.

### Clause 4

The computer-implemented method of Clause 3, wherein the set of clarification questions is pre-defined.

### Clause 5

The computer-implemented method of any one of Clauses 1-4, wherein the function plan comprises a second function definition associated with a second function, wherein the second function definition comprises a second hallucination, and the method further comprises: based on determining that a second correct feature is included the user query or a second function schema associated with the second function definition, extracting the second correct feature from the user query or the second function schema; and modifying the second function definition by replacing the second hallucination with the second correct feature.

### Clause 6

The computer-implemented method of any one of Clauses 1-5, wherein determining the hallucination further comprises determining that at least one feature of the function definition does not match a corresponding feature included in either the user query or the function schema.

### Clause 7

The computer-implemented method of Clause 6, wherein the set of features comprises a first function name of the function associated with the function plan, an argument value, and an argument type associated with the argument value.

### Clause 8

The computer-implemented method of Clause 7, wherein the function schema corresponding to the function comprises a second function name, an argument category, and at least one validated argument type associated with the argument category.

### Clause 9

The computer-implemented method of Clause 8, wherein determining that at least one feature of the function definition does not match at least one corresponding feature included in either the user query or the function schema comprises one or more of: determining that the first function name included in the function definition does not match the second function name specified in the function schema; determining that the argument value included in the function definition does not correspond to the argument category specified in the function schema; or determining that the argument value included in the function definition does not match a second argument value included in the user query.

### Clause 10

The computer-implemented method of Clause 8, wherein determining that at least one feature of the function definition does not match at least one corresponding feature included in either the user query or the function schema comprises determining that the user query does not include a particular argument value that corresponds to the argument value included in the function definition.

### Clause 11

The computer-implemented method of any one of Clauses 1-10, wherein the function plan comprises a plurality of function definitions and a planning strategy that determines an order of execution of the plurality of function definitions.

### Clause 12

A computer-implemented method for validating function plans by a device comprising: receiving, as input, a function plan comprising a function definition that comprises a set of features associated with a function a user query, and a function schema that corresponds to the function included in the function plan; determining a hallucination in the function definition by comparing the set features of the function definition with one or more corresponding features included in the user query or the function schema; based on determining the hallucination in the function definition, determining whether a correct feature corresponding to the hallucination is included in either the user query or the function schema; if the correct feature is not included in the user query or function schema, performing function-specific disambiguation to obtain the correct feature; modifying the function definition to include the correct feature; and executing the modified function plan based on whether the correct feature is included in the user query or the function schema.

### Clause 13

A computer-implemented method for validating function plans, comprising: receiving, as input, a first set of features associated with a function definition, and a second set of features associated with a user query and a function schema; comparing the first set of features and the second set of features; identifying a hallucination in the first set of features by determining that at least one feature in the first set of features does not match at least one corresponding feature included in the second set of features; based on identifying the hallucination, determining that a correct feature corresponding to the hallucination is not included in the second set of features; based on determining that the correct feature is not included in the second set of features, selecting a clarification question from a set of pre-defined clarification questions corresponding to the function definition, wherein the clarification question is configured to prompt a user to provide the correct feature; transmitting the clarification question to a user interface; receiving user input comprising the correct feature based on the clarification question; extracting the correct feature from the user input; modifying the function definition by replacing the hallucination with the correct feature; and executing the modified function plan.

### Clause 14

A processing system, comprising: one or more memories comprising computer-executable instructions; and one or more processors configured to execute the computer-executable instructions and cause the processing system to perform a method in accordance with any one of Clauses 1-13.

### Clause 15

A processing system, comprising means for performing a method in accordance with any one of Clauses 1-13.

### Clause 16

A non-transitory computer-readable medium storing program code for causing a processing system to perform the steps of any one of Clauses 1-13.

### Clause 17

A computer program product embodied on a computer-readable storage medium comprising code for performing a method in accordance with any one of Clauses 1-13.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for validating function plans, comprising:
receiving, as input,
a function plan comprising a function definition that comprises a set of features associated with a function,
a user query, and
a function schema that corresponds to the function included in the function plan;
determining a hallucination in the function definition by comparing the set of features of the function definition with one or more corresponding features included in the user query or the function schema;
determining, based on determining the hallucination in the function definition, that a correct feature corresponding to the hallucination is not included in either the user query or the function schema;
performing, based on determining that the correct feature is not included in the user query or the function schema, function argument disambiguation to obtain the correct feature;
modifying the function definition by replacing the hallucination with the correct feature; and
executing the function plan with the modified function definition.

2. The computer-implemented method of claim 1, wherein the function plan comprises a second function definition associated with a second function, wherein executing the function plan further comprises, based on determining that a second hallucination does not exist in the second function definition, executing the function plan without modifying the second function definition.

3. The computer-implemented method of claim 1, wherein performing function argument disambiguation to obtain the correct feature comprises:
selecting a clarification question from a set of clarification questions corresponding to the function, wherein the clarification question is configured to prompt a user to provide the correct feature;
transmitting the clarification question to a user interface;
receiving user input comprising the correct feature based on the clarification question; and
extracting the correct feature from the user input.

4. The computer-implemented method of claim 3, wherein the set of clarification questions is pre-defined.

5. The computer-implemented method of claim 1, wherein the function plan comprises a second function definition associated with a second function, wherein the second function definition comprises a second hallucination, and the method further comprises:
based on determining that a second correct feature is included the user query or a second function schema associated with the second function definition, extracting the second correct feature from the user query or the second function schema; and
modifying the second function definition by replacing the second hallucination with the second correct feature.

6. The computer-implemented method of claim 1, wherein determining the hallucination further comprises determining that at least one feature of the function definition does not match a corresponding feature included in either the user query or the function schema.

7. The computer-implemented method of claim 6, wherein the set of features comprises a first function name of the function associated with the function plan, an argument value, and an argument type associated with the argument value.

8. The computer-implemented method of claim 7, wherein the function schema corresponding to the function comprises a second function name, an argument category, and at least one validated argument type associated with the argument category.

9. The computer-implemented method of claim 8, wherein determining that at least one feature of the function definition does not match at least one corresponding feature included in either the user query or the function schema comprises one or more of:
determining that the first function name included in the function definition does not match the second function name specified in the function schema;
determining that the argument value included in the function definition does not correspond to the argument category specified in the function schema; or
determining that the argument value included in the function definition does not match a second argument value included in the user query.

10. The computer-implemented method of claim 8, wherein determining that at least one feature of the function definition does not match at least one corresponding feature included in either the user query or the function schema comprises determining that the user query does not include a particular argument value that corresponds to the argument value included in the function definition.

11. The computer-implemented method of claim 1, wherein the function plan comprises a plurality of function definitions and a planning strategy that determines an order of execution of the plurality of function definitions.

12. A processing system, comprising: one or more memories comprising computer-executable instructions; and one or more processors configured to execute the computer-executable instructions and cause the processing system to:
receive, as input,
a function plan comprising a function definition that comprises a set of features associated with a function;
a user query, and
a function schema that corresponds to the function included in the function plan;
determine a hallucination in the function definition by comparing the set of features of the function definition with one or more corresponding features included in the user query or the function schema;
based on determining the hallucination in the function definition, determine whether a correct feature corresponding to the hallucination is included in either the user query or the function schema;
if the correct feature is not included in the user query or the function schema,
perform function-specific disambiguation to obtain the correct feature, and
modify the function definition of the function plan to include the correct feature; and
execute the function plan based on whether the correct feature is included in the user query or the function schema.

13. The processing system of claim 12, wherein the function plan comprises a second function definition associated with a second function, wherein the processing system is caused to execute the function plan by, based on determining that a second hallucination does not exist in the second function definition, executing the function plan without modifying the second function definition.

14. The processing system of claim 12, wherein the processing system is caused to perform function specific disambiguation to obtain the correct feature by:
selecting a clarification question from a set of clarification questions corresponding to the function, wherein the clarification question is configured to prompt a user to provide the correct feature;
transmitting the clarification question to a user interface;
receiving user input comprising the correct feature based on the clarification question; and
extracting the correct feature from the user input.

15. The processing system of claim 14, wherein the set of clarification questions is pre-defined.

16. The processing system of claim 12, wherein the function plan comprises a second function definition associated with a second function, wherein the second function definition comprises a second hallucination, and the processing system is further caused to:
extract, based on determining that a second correct feature is included the user query or a second function schema associated with the second function definition, the second correct feature from the user query or the second function schema; and
modify the second function definition by replacing the second hallucination with the second correct feature.

17. The processing system of claim 12, wherein the processing system is caused to determine the hallucination by determining that at least one feature of the function definition does not match a corresponding feature included in either the user query or the function schema.

18. The processing system of claim 17, wherein the set of features comprises a first function name of the function associated with the function plan, an argument value, and an argument type associated with the argument value.

19. The processing system of claim 18, wherein the function schema corresponding to the function comprises a second function name, an argument category, and at least one validated argument type associated with the argument category.

20. A computer-implemented method for validating function definitions, comprising:
receiving, as input,
a first set of features associated with a function definition, and
a second set of features associated with a user query and a function schema;
comparing the first set of features and the second set of features;
identifying a hallucination in the first set of features by determining that at least one feature in the first set of features does not match at least one corresponding feature included in the second set of features;
based on identifying the hallucination, determining that a correct feature corresponding to the hallucination is not included in the second set of features;
based on determining that the correct feature is not included in the second set of features, selecting a clarification question from a set of pre-defined clarification questions corresponding to the function definition, wherein the clarification question is configured to prompt a user to provide the correct feature;
transmitting the clarification question to a user interface;
receiving user input comprising the correct feature based on the clarification question;
extracting the correct feature from the user input;
modifying the function definition by replacing the hallucination with the correct feature; and
executing the modified function definition.
